(19) United States
(12) Patent Application Publication
(10) Pub. No.: US 2003/0097471 A1
(43) Pub. Date: May 22, 2003

(54) Routing in transmission networks

(75) Inventor: Gert Grammel, Uhingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/298,939

(22) Filed: Nov. 19, 2002

(30) Foreign Application Priority Data
Nov. 20, 2001 (EP) 01 440 395.0

(51) Int. Cl. G06F 15/173

(52) U.S. Cl. 709/239

(57) ABSTRACT

The invention has for its object to provide faster routing. The SONET, SDH, or OTN network according to the invention comprises at least two network elements which are directly or indirectly connected with one another and are each adapted to autonomously determine and set up a path through at least a portion of the SONET, SDH, or OTN network, the path determination being based on connection information stored in the network elements and on a destination address contained in the path identifier. The OTN network may also include WDM nodes and IP routers, for example. A network element is, for instance, a WDM node, an IP router, a network node, a multiplexer, a cross connect, an add/drop multiplexer, etc. The connection information contains information as to which network element is connected to which.

### TECHNICAL FIELD

This invention relates to a SONET, SDH, or OTN network, a routing method, a network element, and a network route processor. The invention is based on a priority application No.EP 01 440 395.0, which is hereby incorporated by reference.

### BACKGROUND OF THE INVENTION

WO 00/44118 discloses an optical network with an optical signaling header. Packet routing information is transmitted in the same channel or wavelength as the data payload. Thus, both the header and the data payload propagate through the network elements using the same path, so that the same delays occur. Packet routing requires peer-to-peer communication for the exchange of routing information.

### SUMMARY OF THE INVENTION

It is an object of the invention to provide faster routing.

According to the invention, this object is attained by a SONET, SDH, or OTN network comprising at least two network elements which are directly or indirectly connected with one another and are each adapted to determine and set up a path through at least a portion of the SONET, SDH, or OTN network, the determination of the path being based on connection information stored in the network elements and on a destination address contained in the path identifier. This object is further attained by a method of setting up a path through a SONET, SDH, or OTN network wherein a path identifier containing a destination address is transmitted, and wherein network elements in the SONET, SDH, or OTN network determine and set up the path autonomously, the determination of the path being based on connection information stored in the network elements and on the destination address. This object is further attained by a network element for a SONET, SDH, or OTN network, the network element comprising a processor and a memory for receiving and storing connection information and a path identifier as well as for determining a path through at least a portion of the SONET, SDH, or OTN network on the basis of connection information and of a destination address contained in the path identifier and for autonomously setting up a path to an adjacent network element. This object is further attained by a network route processor for controlling at least one network element for a SONET, SDH, or OTN network, the network route processor comprising a processor and a memory for receiving and storing connection information and a path identifier as well as for determining a path through at least a portion of the SONET, SDH, or OTN network on the basis of connection information and of a destination address contained in the path identifier and for controlling the at least one network element for the purpose of setting up the path.

Network nodes in transmission networks are enabled to autonomously set up a path through the entire network. Instead of tying up packet information on the path serving for transmission as is usually the case with routers, for example, use is made of status information in the transmission layer. This permits a higher speed of response, i.e., routing through the network is accelerated. Furthermore, existing features from SONET, SDH, and OTN networks can be used; SONET=Synchronous Optical Network, SDH=Synchronous Digital Hierarchy, OTN=Optical Transmission Network. Moreover, the invention can be applied to existing equipment by using network route processors.

In SONET, SDH, and OTN networks, overhead information is transmitted for supervision and maintenance purposes in addition to the payload information. This overhead information is associated, on the one hand, with the payload and, on the other hand, with the segment of the network in which it is valid.

In SONET and SDH networks, the overhead information contains, for example, an assignment to the regenerator section on the link between two regenerators and an assignment to a multiplex section on the link between two multiplexers or two cross connects. Between two so-called client service devices, the path overhead is transmitted.

The section or path identifier is encoded in such a way that it contains information about the terminal it is connected to. This can be done, for example, by using the IP address of the terminal or any other address by which the terminal is identifiable; IP=Internet Protocol.

At least one end of the connection, advantageously both ends, are identified. In the case of multicast connections, the identifier field may contain more than two end addresses.

Based on the end point identification, a network node can determine a path through the network using a routing engine incorporated in the node. This is achieved by exchanging connection information between the network nodes. This connection information is based on protocols and the infrastructure and is not necessarily identical with the actual physical node connections.

Based on this connection information, routing in SONET, SDH, and OTN networks is possible without the use of packet information or link status information which is based on this packet information.

Direct access to the overhead information allows fast error detection and correction.

For networks that are already in operation, a network route processor can be introduced which performs the routing task on behalf of the network elements.

It is not necessary for packet-based routing information to be transported over the same physical infrastructure as the data payload. Information about the availability of connections can be exchanged between the network elements without the need to provide point-to-point connections. This speeds up the routing process.

The SONET, SDH, or OTN network according to the invention comprises at least two network elements which are directly or indirectly connected with one another and are each adapted to determine and set up a path through at least a portion of the SONET, SDH, or OTN network, the determination of the path being based on connection information stored in the network elements and on a destination address contained in the path identifier. The OTN network may also comprise WDM nodes and IP routers, for example; WDM=Wavelength Division Multiplexing. A network element is, for instance, a WDM node, an IP router, a network node, a multiplexer, a cross connect, an add/drop multiplexer, etc. The connection information contains information as to which network element is connected to which. Thus, each network element has an overall view of at least portions of the network and can decide autonomously which adjacent network element the path should be routed to. The path is set up in the direction of the destination address if possible, taking into account the smallest number of intermediate network elements.

In a preferred embodiment, an overlay network is provided over which the connection information is distributed. To avoid blocking the data network with additional information, an overlay network may be introduced which serves to transmit connection information. The data and the path information are transmitted over the SONET, SDH, or OTN network, and the connection information is transmitted over the separate overlay network. The overlay network may be the network management net, which also serves to transmit supervisory information, maintenance information, etc.

In the method according to the invention for setting up a path through the SONET, SDH, or OTN network, a path identifier containing a destination address is transmitted, and network elements in the SONET, SDH, or OTN network determine and set up the path autonomously, the determination of the path being based on connection information stored in the network elements and on the destination address.

The network element according to the invention for a SONET, SDH, or OTN network comprises a processor and a memory for receiving and storing connection information and a path identifier as well as for determining a path through at least a portion of the SONET, SDH, or OTN network on the basis of connection information and of a destination address contained in the path identifier and for autonomously setting up a path to an adjacent network element. The processor is designed as a digital signal processor (DSP) or a microprocessor, for example. It is suitably programmed to perform the required tasks. The programming is done in the programming language C++, for example.

The network route processor according to the invention serves to control at least one network element for a SONET, SDH or OTN network and comprises a processor and a memory for receiving and storing connection information and a path identifier as well as for determining a path through at least a portion of the SONET, SDH, or OTN network on the basis of connection information and of a destination address contained in the path identifier and for controlling the at least one network element for the purpose of setting up the path.

Further advantageous aspects of the invention are apparent from the dependent claims and the following description.

### BRIEF DESCRIPTION OF THE DRAWING

Three embodiments of the invention will now be explained with reference to the accompanying drawings, in which:

FIG. 1 is a schematic representation of a network with two routers and four network elements;

FIG. 2 is another schematic representation of a network with two routers and four network elements;

FIG. 3 shows an example of a path setup;

FIG. 4 shows an example of how a new path is found in the event of a failure; and

FIG. 5 is a schematic representation of a network with outsourced routing decision.

### BEST MODE FOR CARRYING OUT THE INVENTION

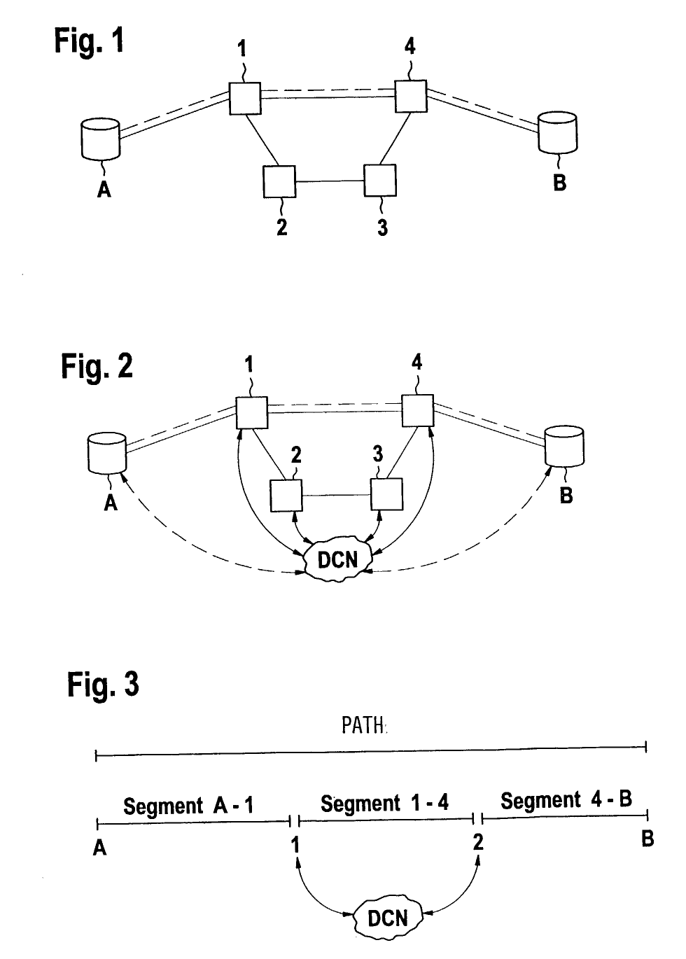

The first embodiment will now be explained with reference to FIG. 1. FIG. 1 shows a network with two routers and four network elements. A network element is, for example, a cross connect, a multiplexer, a regenerator, or a network node. Router A is connected via a series combination of network element 1 and network element 4 to router B. Network element 2 is connected via a series combination of network element 2 and network element 3 to network element 4.

Connection information that can be derived from the segment overhead:

Router A is connected to network element 1.

Network element 1 is connected to network element 2, network element 4, and router A.

Network element 2 is connected to network element 1 and network element 3.

Network element 3 is connected to network element 2 and network element 4.

Network element 4 is connected to network element 1, network element 3, and router B.

Router B is connected to network element 4.

Connection information that can be derived from the path overhead:

Router A is connected to router B.

Network element 1 serves the connection between router A and router B.

Network element 2 does not serve any connection.

Network element 3 does not serve any connection.

Network element 4 serves the connection between router A and router B.

In the network, the connection information is distributed. Each network element which receives the connection information can create its own view of the network topology. The received connection information is stored in a connection table, for example. If, for example, the link between network elements 1 and 4 is faulty, network element 1 can decide autonomously based on the information from the connection table to reroute the faulty link to network element 2. Based on the same mechanism, network element 2 can route the rerouted link to the network element 3, and network element 3 can route the link to network element 4.

When a network element receives new path information at one of its inputs, it checks if it is directly connected with a segment to the destination address of the path. For instance, network element 2 receives path information with the destination address “router B”. Network element 2 checks whether it is directly connected with router B. If that is the case, the path will be set up. If not, a possible path will be selected by referring to the connection table, and the path will be routed to the next network element. Network element 2 will thus route the path to network element 1 or 3.

The second embodiment will now be explained with reference to FIGS. 2 to 4. FIG. 2 shows the network of FIG. 1 and an overlay network. The overlay network DCN is supplied with the connection information. It creates a connection table, on the basis of which the paths are set up. The connections from the overlay network DCN to routers A and B are optional, since the information provided by routers A and B is redundant; this information is already present in network elements 1 and 4, respectively.

FIG. 3 shows an example of a path setup.

A path is to be established between router A and router B.

In a first step, router A is connected to network element 1. To this end, router A inserts its ID into the segment overhead from router A to network element 1; ID=Identifier Information. Network element 1 receives the ID from router A and, in turn, inserts its ID into the segment overhead from network element 1 to router A. Router A and network element 1 store the new connection information in their respective local databases. The new connection information says that router A can be reached via network element 1 and vice versa. Analogous operations can be performed for all connections between network elements and between network elements and routers.

In a second step, the new connection information is distributed by network element 1. The new connection information is transmitted, e.g., broadcast, to all network elements connected to network element 1, e.g., to network element 4. From the received new connection information, network element 4 derives the information that router A can be reached via network element 1 and vice versa. This information is stored in network element 4. Analogous operations can be performed for all other connections between network elements and between network elements and routers. All network elements then have a complete view of the network. The first two steps can be performed within a central initialization process and are then optional for the establishment of a single path.

In a third step, router A sets up a path on the segment “router A—network element 1” with the information “connection router A—router B” in the path identifier. Network element 1 detects the new path identifier in the segment “router A—network element 1” and checks its database for the next possible connection in the direction of the destination address “router B”. Network element 1 then sets up the path “router A—network element 1—network element 4”. Network element 4 detects the new path identifier in the segment “network element 1—network element 4” and, after checking its routing database, sets up the path “network element 1 network element 4—router B”.

In a fourth step, router B detects a new connection. The path identifier identifies router A as the end point of the new connection. The path “router A—router B” has been set up. Communication takes place between router A and router B.

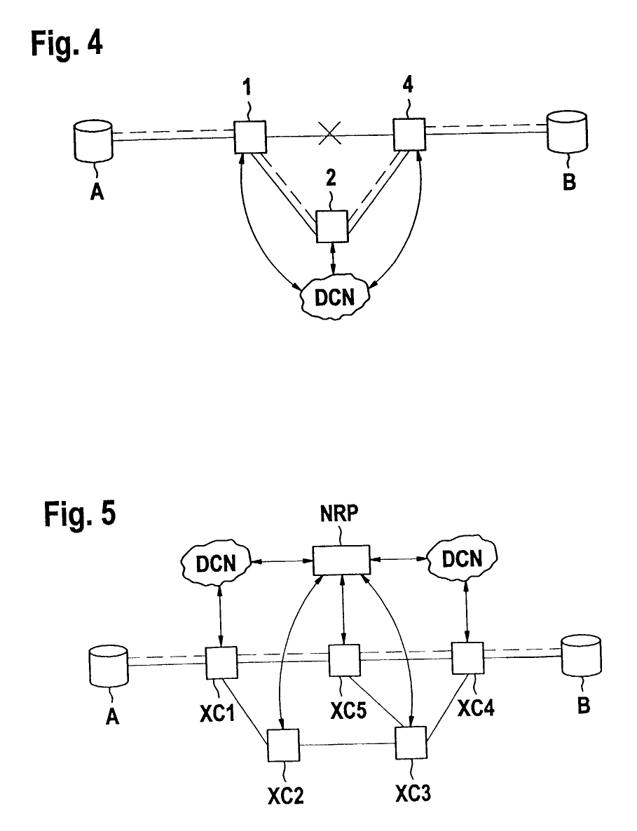

FIG. 4 shows an example of how a new path is found in the event of failure. The network resembles the network of FIG. 2 except that network element 3 has been omitted for simplicity.

In a first step, network element 1 detects a line fault between network element 1 and network element 4 by evaluating the overhead information on the segment “network element 1—network element 4”.

In a second step, network element 1 distributes the fault information over the overlay network DCN. All network-element databases are updated accordingly. In addition to network element 1, network element 4 may distribute this information.

In a third step, network element 1 decides to put the path “router A—router B” on the segment “network element 1—network element 2”. Network element 1 will make this decision based on its database and on the next open connection.

In a fourth step, network element 2 detects the new path information on the segment “network element 1—network element 2”. After evaluating the path information, network element 2 will decide to put the path “router A router B” on the segment “network element 2—network element 4”.

In a fifth step, network element 4 detects the new path information on the segment “network element 2—network element 4”. After evaluating the path information, network element 4 will decide to put the path “router A—router B” on the segment “network element 4—router B”. This way a bypass around the fault is created.

Alternatively to the fifth step, network element 4 may configure a select function which, irrespective of the origin of the information, forwards that segment to the router B on which the better quality of reception is present. If, for example, the fault on the segment “network element 1—network element 4” is only temporary, and the quality being received by network element 4 on the segment “network element 1—network element 4” is better than that being received on the segment “network element 2—network element 4”, then network element 4 will set up the path “network element 1—network element 4—router B” as soon as the fault has been removed.

The third embodiment will now be explained with reference to FIG. 5. FIG. 5 shows a network with outsourced routing decision.

The network contains two routers A and B, five network elements XC1 to XC5 in the form of cross connects, a network route processor NRP, and two overlay networks DCN, which may also be combined in one network.

Network elements XC1 and XC4 are new network elements which are capable of performing routing autonomously using their respective own connection tables. Network elements XC2, XC3, XC5 are network elements that are already in operation and whose routing tasks have been outsourced to network route processor NRP. Existing networks can thus be expanded in a simple manner, and a mixture of new and old network elements can be used. Router A is connected via a series combination of network elements XC1, XC5, XC4 to router B. Network element XC1 is connected via a series combination of network elements XC2, XC3 to network element XC4. Network element XC5 is connected to network element XC3.

The routing operations, the setting up of the paths, the creation of connection tables, the distribution of the connection information, etc. are analogous to the network of FIG. 2.

Network route processor NRP supervises the traffic on the overlay network DCN on behalf of network elements XC2, XC3, XC5, particularly for purposes of a path setup. It routes the path inside the subnetwork formed by network elements XC2, XC3, XC5 and instructs the latter to establish the path in the appropriate manner. In the event of a failure within the subnetwork, network route processor NRP can decide autonomously on a bypass and set up the bypass without flooding the overlay network DCN with unnecessary information.

In all embodiments, a rather small number of elements is present. This contributes to clarity and facilitates the exemplary explanation of the principle. The networks may comprise a large number of elements, e.g., one hundred or one thousand routers, one hundred or one thousand network elements, one or more, e.g., ten, overlay networks, and one or more, e.g., ten, network route processors. The network route processors are organized hierarchically, for example; a network route processor controls e.g. three network route processors which, in turn, control a number of network elements.

1. A SONET, SDH, or OTN network comprising at least two network elements which are directly or indirectly connected with one another and are each adapted to determine and set up a path through at least a portion of the SONET, SDH, or OTN network, the determination of the path being based on connection information stored in the network elements and on a destination address contained in the path identifier.

2. A SONET, SDH, or OTN network as set forth in claim 1, characterized in that there is provided at least one overlay network over which the connection information is distributed.

3. A method of setting up a path through a SONET, SDH, or OTN network wherein a path identifier containing a destination address is transmitted, and wherein network elements in the SONET, SDH, or OTN network determine and set up the path autonomously, the determination of the path being based on connection information stored in the network elements and on the destination address.

4. A network element for a SONET, SDH, or OTN network, the network element comprising a processor and a memory for receiving and storing connection information and a path identifier as well as for determining a path through at least a portion of the SONET, SDH, or OTN network on the basis of connection information and of a destination address contained in the path identifier and for autonomously setting up a path to an adjacent network element.

5. A network route processor for controlling at least one network element for a SONET, SDH, or OTN network, the network route processor comprising a processor and a memory for receiving and storing connection information and a path identifier as well as for determining a path through at least a portion of the SONET, SDH, or OTN network on the basis of connection information and of a destination address contained in the path identifier and for controlling the at least one network element for the purpose of setting up the path.
